(19) United States
(12) Patent Application Publication
(10) Pub. No.: US 2013/0247179 A1
(43) Pub. Date: Sep. 19, 2013

(54) SYSTEM, METHOD, AND COMPUTER PROGRAM PRODUCT FOR SENDING DATA ASSOCIATED WITH CONTENT TO A SERVER FOR ANALYSIS

(71) Applicants: Abhilash Chandran, Kollam (IN); Harish Chakkingal, Bangalore (IN)

(72) Inventors: Abhilash Chandran, Kollam (IN); Harish Chakkingal, Bangalore (IN)

(21) Appl. No.: 11/773,350

(22) Filed: Jul. 3, 2007

(51) Int. Cl. G06F 21/00; G06F 15/16

(52) U.S. Cl. 726/22; 726/1

(57) ABSTRACT

A system, method, and computer program product are provided for sending data associated with content to a server for analysis. In use, tracking information associated with content stored on a client is identified. Further, data associated with the content is sent from the client to a server for analysis.

### FIELD OF THE INVENTION

The present invention relates to content analysis, and more particularly to analyzing content for various purposes (e.g. to determine if it is safe, etc.).

### BACKGROUND

Traditionally, content security has been provided by various types of security systems (e.g. virus scanners, etc.). Such security systems have typically provided such content security by analyzing content using a variety of techniques. However, such analysis performed by conventional security systems has generally exhibited various limitations. Just by way of example, criteria utilized in prioritizing the analysis of different content has generally been limited, if not non-existent. To this end, content that should be analyzed with a higher priority is oftentimes analyzed with a lower priority, etc.

There is thus a need for addressing these and/or other issues associated with the prior art.

### SUMMARY

A system, method, and computer program product are provided for sending data associated with content to a server for analysis. In use, tracking information associated with content stored on a client is identified. Further, data associated with the content is sent from the client to a server for analysis.

### BRIEF DESCRIPTION OF THE DRAWINGS

FIG. 1 illustrates a network architecture, in accordance with one embodiment.

FIG. 2 shows a representative hardware environment that may be associated with the servers and/or clients of FIG. 1, in accordance with one embodiment.

FIG. 3 shows a method for sending data associated with content to a server for analysis, in accordance with one embodiment.

FIG. 4 shows a client-based method for communicating prioritized uniform resource locators to a server, accordance with another embodiment.

FIG. 5 shows a server-based method for analyzing uniform resource locators based on a priority thereof in accordance with yet another embodiment.

FIG. 6 shows a high level schematic of an interactive reputation-based platform with which the various features of the embodiments of the previous figures may or may not be utilized, in accordance with still yet another embodiment.

### DETAILED DESCRIPTION

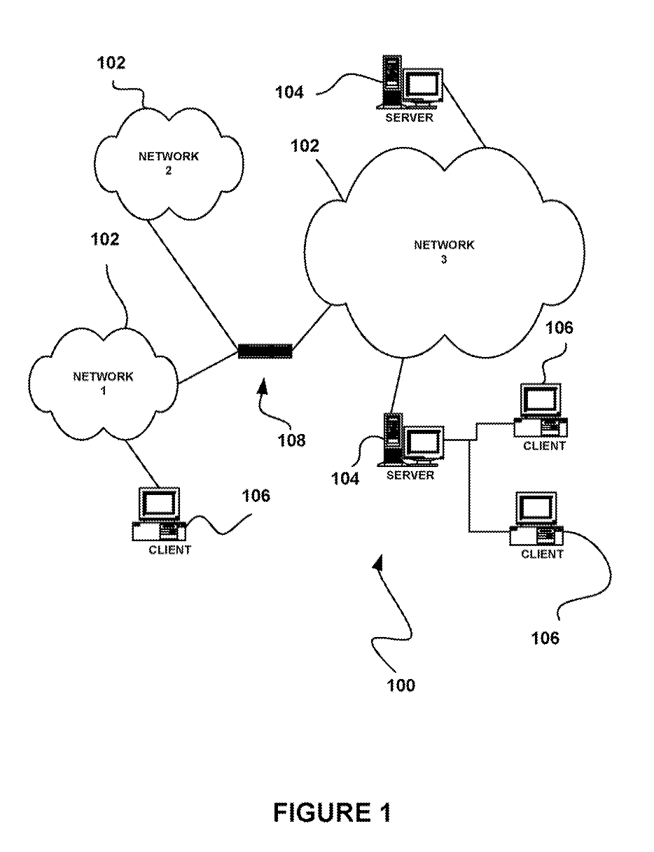

FIG. 1 illustrates a network architecture 100, in accordance with one embodiment. As shown, a plurality of networks 102 is provided. In the context of the present network architecture 100, the networks 102 may each take any form including, but not limited to a local area network (LAN), a wireless network, a wide area network (WAN) such as the Internet, a peer-to-peer network, a personal area network (PAN), etc.

Coupled to the networks 102 are servers 104 which are capable of communicating over the networks 102. Also coupled to the networks 102 and the servers 104 is a plurality of clients 106. Such servers 104 and/or clients 106 may each include a desktop computer, lap-top computer, hand-held computer, mobile phone, personal digital assistant (PDA), peripheral (e.g. printer, etc.), any component of a computer, and/or any other type of logic. In order to facilitate communication among the networks 102, at least one gateway 108 is optionally coupled therebetween.

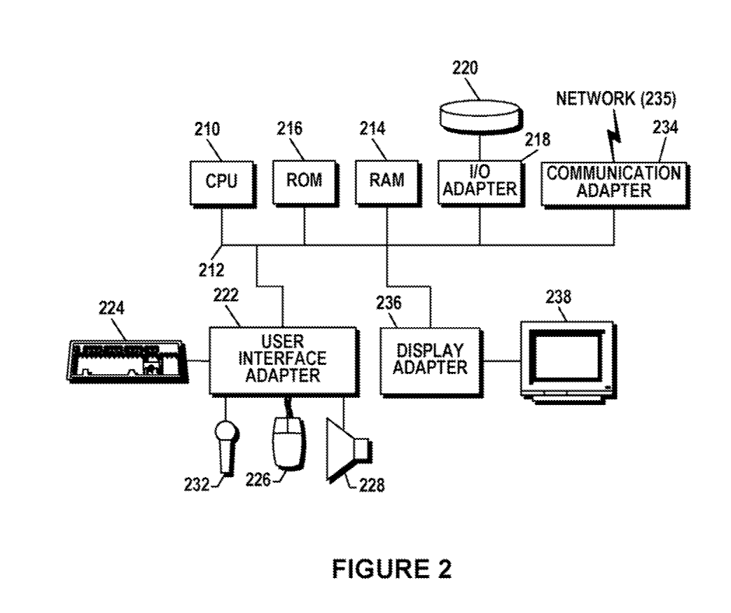

FIG. 2 shows a representative hardware environment that may be associated with the servers 104 and/or clients 106 of FIG. 1, in accordance with one embodiment. Such figure illustrates a typical hardware configuration of a workstation in accordance with one embodiment having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen (not shown) to the bus 212, communication adapter 234 for connecting the workstation to a communication network 235 (e.g., a data processing network) and a display adapter 236 for connecting the bus 212 to a display device 238.

The workstation may have resident thereon any desired operating system. It will be appreciated that an embodiment may also be implemented on platforms and operating systems other than those mentioned. One embodiment may be written using JAVA, C, and/or C++ language, or other programming languages, along with an object oriented programming methodology. Object oriented programming (OOP) has become increasingly used to develop complex applications.

Of course, the various embodiments set forth herein may be implemented utilizing hardware, software, or any desired combination thereof. For that matter, any type of logic may be utilized which is capable of implementing the various functionality set forth herein.

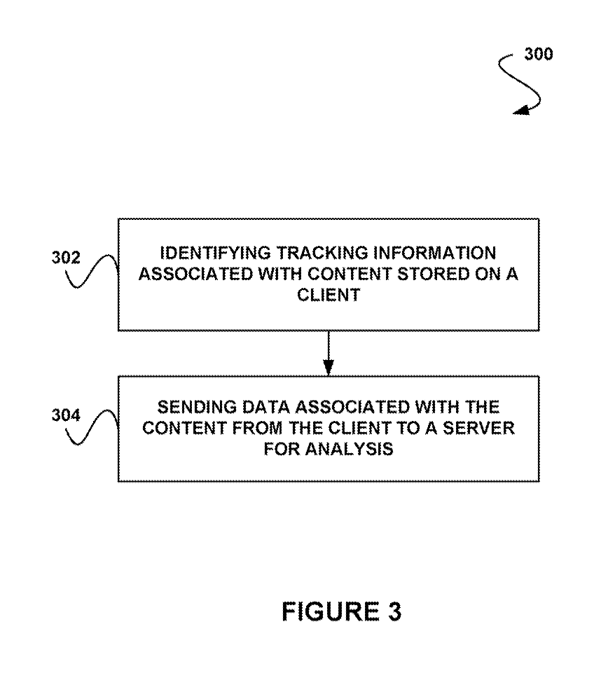

FIG. 3 shows a method 300 for sending data associated with content to a server for analysis, in accordance with one embodiment. As an option, the method 300 may be carried out in the context of the architecture and environment of FIGS. 1 and/or 2. Of course, however, the method 300 may be carried out in any desired environment.

As shown in operation 302, tracking information (associated with content) that is stored on a client is identified. The client on which the tracking information is stored may include any device capable of storing such tracking information and further capable of communicating with a server. For example, the client may include any of the devices described above with respect to FIGS. 1 and/or 2.

Optionally, the client may also be utilized for accessing the content. In one embodiment, the content may include a web site. Of course, it should be noted that the content may also include any content to which tracking information is capable of being associated.

Thus, for example, the content may be accessed over a network (e.g. by a user utilizing a web browser of the client, etc.). To this end, the content may be accessed manually (e.g. by a user), in one embodiment. In another embodiment, the content may be accessed automatically. For example, the content may be accessed automatically utilizing a computer program (e.g. a web crawler, etc.).

In addition, in the context of the present description, the tracking information may include any information associated with the content that is capable of being utilized for tracking purposes. For example, such tracking purposes may include tracking access to the content. As another example, the tracking purposes may include tracking inputted data (e.g. user information, financial information, address information, etc.) with respect to the content. Still yet, the tracking information may be utilized by a publisher of the content and/or any other user for such tracking, purposes.

In one embodiment, the tracking information may indicate a location of the content [e.g. a uniform resource locator (URL)], a type of the content, a time the content was accessed, etc. In another embodiment, the tracking information may indicate information associated with a user, such as an identifier of the user, an identifier of the client, etc. In yet another embodiment, the tracking information may indicate a time period for which the tracking information is valid.

Just by way of example, the tracking information may include a cookie. Thus, the cookie may optionally store data (e.g. user information, etc.) associated with accesses to the content. As another example, the tracking information may include a file (e.g. text file, etc.). Of course, however, the tracking information may be stored on the client in any desired form.

Moreover, the tracking information may be identified utilizing a computer program stored on the client. For example, such computer program may include a plug-in. As another example, the computer program may include an agent. Optionally, the computer program may scan memory of the client for the tracking information automatically and/or on an on-demand basis. Of course, however, the tracking information may be identified in any desired manner.

As also shown in operation 304, data associated with the content is sent from the client to a server for analysis. Such server may include any device capable of receiving data for analysis. Just by way of example, the server may include any of the devices described above with respect to FIGS. 1 and/or 2. Optionally, the server may include a security system installed thereon for performing the analysis.

In addition, the data associated with the content that is sent to the server may include any data capable of being associated with the content. In one embodiment, the data may include the content itself, or a portion thereof. In another embodiment, the data may include a URL, associated with the content (e.g. indicating a location of the content, etc.). As an option, the data may be identified from the tracking information.

Further, the data may be sent from the client to the server in any desired manner. In one embodiment, the data may be sent to the server over a network. For example, such network may include any of networks described above with respect to FIG. 1.

Still yet, the analysis for which the data is sent to the server may include any desired types of analysis capable of being performed on the data. For example, the analysis may include identifying content associated with the data (e.g. utilizing the data), and analyzing the content. In one embodiment, the analysis may include categorizing the data and/or the content associated therewith. For instance, such categorization may identify whether the content is wanted (e.g. is safe, is appropriate, complies with a policy, has a good reputation, etc.) or unwanted (e.g. is unsafe, is inappropriate, violates a policy, has a bad reputation, etc.). The categorization may also identify a type of the content (e.g. spam, malware, porn, etc.). As another option, the analysis may include determining a safety ranking of the content to which the data is associated. To this end, data associated with content for which tracking information is identified may be sent from a client to a server for analysis.

More illustrative information will now be set forth regarding various optional architectures and features with which the foregoing technique may or may not be implemented, per the desires of the user. It should be strongly noted that the following information is set forth for illustrative purposes and should not be construed as limiting in any manner. Any of the following features may be optionally incorporated with or without the exclusion of other features described.

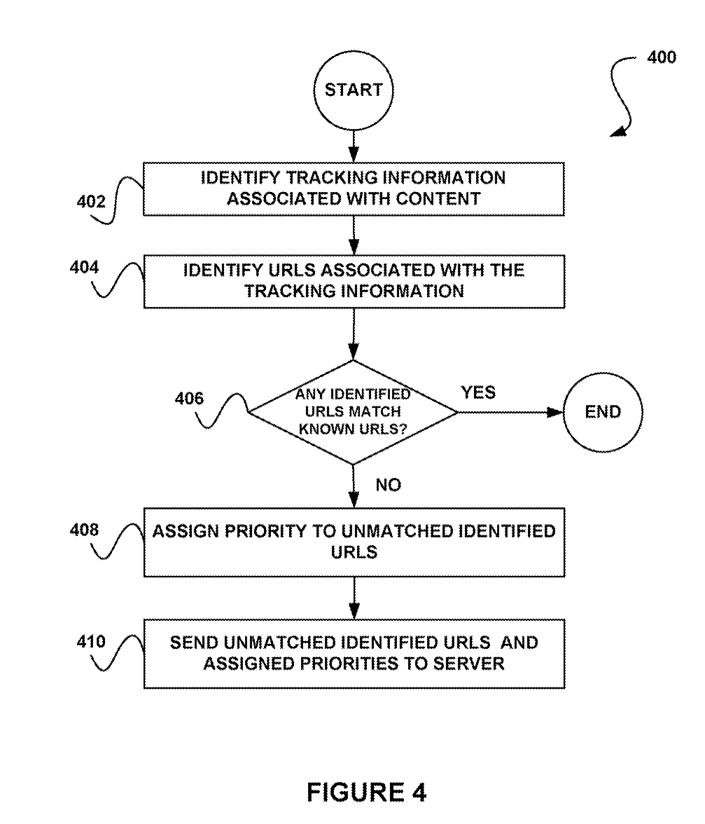

FIG. 4 shows a client-based method 400 for communicating prioritized uniform resource locators to a server, in accordance with another embodiment. As an option, the method 400 may be carried out in the context of the architecture and environment of FIGS. 1-3. Of course, however, the method 400 may be carried out in any desired environment. It should also be noted that the aforementioned definitions may apply during the present description.

As shown in operation 402, tracking information associated with content is identified. The tracking information may optionally be particular to multiple different types of content. Just by way of example, the tracking information may include a plurality of cookies, each associated with different content.

Additionally, URLs associated with the tracking information are identified. Note operation 404. The URLs may indicate a location of the content to which the tracking information is associated. For example, the location may include a location on a network. In this way, each different type of content may be associated with a different URL.

In one embodiment, the URLs may be identified by parsing the tracking information. For example, tracking information associated with each different type of content may be parsed for identifying a URL therein. Thus, such URL may be stored in the tracking information, as an option. Of course, however, the URL may be identified in any desired manner.

Furthermore, it is determined whether any of the identified URLs match known URLs, as shown in decision 406. In the context of the present embodiment, the known URLs may include URLs associated with known content. Such known content may have been previously analyzed. For example, analysis results associated with the known content may have indicated that the known content is wanted, unwanted, etc. Thus, the known URLs may indicate that the associated content is wanted, unwanted, etc.

In one embodiment, the known URLs may be stored in a definition file. In this way, such definition file may include URLs associated with known wanted content, known unwanted content, etc., and may therefore be utilized for determining whether content (e.g. accessed content, etc.) is wanted, unwanted, etc. Optionally, the definition file may be utilized for filtering content accessed via URLs matching known URLs stored therein.

In one embodiment, the known URLs may be stored on the client on which the tracking information is identified. Of course, in another embodiment, the known URLs may also be stored on a server remotely located with respect to such client. For example, the known URLs may be communicated from the server to the client (e.g. as updates to the definition file, etc.).

Moreover, the determination whether any of the identified URLs match the known URLs may be performed by comparing the identified URLs to the known URLs. Such comparison may be made in any desired manner. Still yet, the determination may be made at the client (e.g. by a security system installed on the client, a plug-in which identified the tracking information, etc.).

If it is determined that any of the identified URLs do not match known URLs, a priority is assigned to such unmatched identified URLs. Note operation 408. In one embodiment, the priority may be predefined. For example, the priority may be predefined by a user. Of course, however, the priority may be determined in any desired manner.

Thus, for example, the priority may include a high priority, if it is determined that any of the identified URLs do not match known URLs (thus indicating that the status of the associated content is not known). In another embodiment, the priority may be assigned to the unmatched identified URLs by setting a flag associated therewith. The flag may therefore indicate the assigned priority. Such flag may be appended to each of the unmatched identified URLs, for example. As another option, a bit associated with the unmatched identified URLs may also be set for indicating the priority.

Still yet, the unmatched identified URLs and the associated assigned priorities are sent to a server, as shown in operation 410. Thus, a priority may be assigned to the each of the unmatched identified URLs at the client prior to sending such URLs to the server. Furthermore, the unmatched identified URLs and priorities assigned thereto may be sent from the client to the server for analysis purposes. In this way, a client may be utilized for identifying tracking information located thereon that is associated with content, and sending a URL of such content to a server for analysis, if it is determined that the URL does not match known URLs associated with known content.

It should be noted that, while it is shown that the determination of whether any of the identified URLs match known URLs is performed at the client, such determination may also be performed at a server. For example, in response to identifying URLs associated with tracking information stored on the client, all such identified URLs may be sent to the server. Accordingly, in response to receipt of the identified URLs, the server may determine whether such URLs match known URLs.

In this way, a processing load placed on the resources of the client may be limited by performing the determination at the server. In addition, performing the determination at the server may allow the identified URLs to be compared to a more comprehensive list of known URLs, for example, in a situation where the client is not necessarily up-to-date with the latest known URLs. To this end, priorities may further be assigned to any unmatched identified URLs at the server.

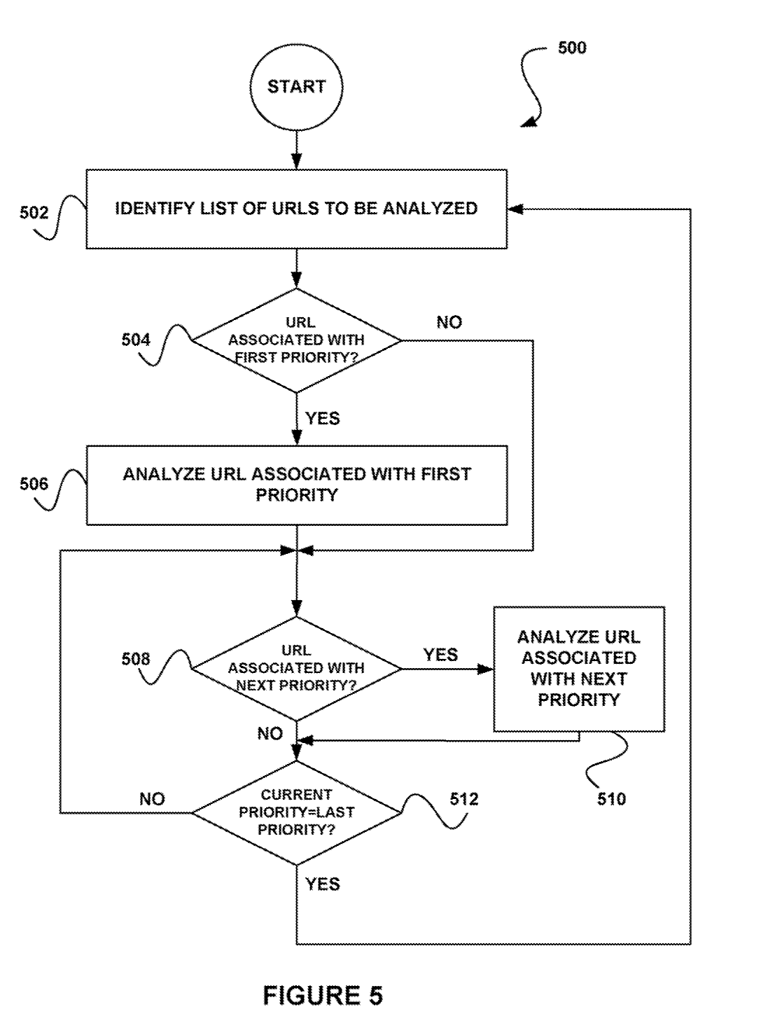

FIG. 5 shows a server-based method 500 for analyzing uniform resource locators based on a priority thereof, in accordance with yet another embodiment. As an option, the method 500 may be carried out in the context of the architecture and environment of FIGS. 1-4. Of course, however, the method 500 may be carried out in any desired environment. Again, it should also be noted that the aforementioned definitions may apply during the present description.

As shown in operation 502, a list of URLs to be analyzed is identified. In the context of the present embodiment, the list of URLs may include any URLs received from a client which have been determined to not match any known URLs. Optionally, URLs within the list of URLs may be prioritized. For example, such prioritization may be based on priorities assigned to the URLs.

In one embodiment, URLs associated with content for which tracking information was identified may be assigned a high priority, whereas URLs associated with content for which tracking information was not identified may be assigned a lower priority. Of course, it should be noted that URLs associated with content for which tracking information was not identified may be assigned priorities based on any other desired criteria. Optionally, such criteria and associated priorities may be user defined.

Additionally, it is determined whether any URL in the list of URLs is associated with a first priority, as shown in decision 504. In the context of the present description, the first priority may include a highest priority. Such determination may be made by identifying priorities assigned to the URLs in the list and comparing such priorities to the first priority, in one embodiment. Of course, however, the determination may be made in any desired manner.

If it is determined that none of the URLs in the list are associated with the first priority, it is determined whether any of such URLs are associated with a next priority (note decision 508, as described below). If, however, it is determined that at least one of the URLs in the list is associated with the first priority, any of such URLs associated with the first priority are analyzed. Note operation 506.

The analysis may include identifying content associated with URLs as unwanted, wanted, etc. For example, the analysis may include performing a virus scan on the content, identifying vulnerabilities associated with the content, etc. As further shown in decision 508, in response to the analysis of URLs associated with the first priority, it is determined whether any URLs in the list are associated with a next priority.

In response to a determination that at least one URL in the list is associated with the next priority, any of such URLs associated with the next priority are analyzed, as shown in operation 510. In response to a determination that none of the URLs in the list are associated with the next priority, it is determined whether the current priority (i.e. the next priority of operation 508) is a last priority, as shown in decision 512. In one embodiment, the determination may be made based on a comparison of such current priority with a predefined last priority. In another embodiment, the determination may be made based on whether an end of the URL list has been reached.

If it is determined that the current priority is not the last priority, it is determined whether any of the URLs in the list are associated with yet a next priority and associated content is analyzed, as shown in decision 508 and operation 510. However, in response to a determination that the current priority is the last priority, the list of URLs to be analyzed is again identified (operation 502). To this end. URLs may be analyzed in an order based on priorities associated therewith.

As an option, in response to the analysis of the URLs, results of such analysis may be communicated to a client in communication with the server that performed the analysis. In one embodiment, the results may include generated rules. For example, the rules may indicate whether content associated with the analyzed URLs is wanted, unwanted, etc. As another example, the rules may indicate a safety ranking of the content associated with the analyzed URLs.

Moreover, the analysis results may optionally include an update to a definition file stored on the client, in one embodiment. Further, the analysis results may be communicated to the client based on a schedule (e.g. periodically, etc.), in a streaming manner (e.g. when use of resources of the client is limited, etc.), etc. Thus, in one embodiment, the client may utilize the analysis results for identifying such results when content associated with the URL is accessed. For example, if a user of the client accesses content utilizing a URL for which there are analysis results, an alert may be communicated to the user if the analysis results indicate that the content associated with the URL is unwanted, etc. In another embodiment, the analysis results may also be utilized for determining whether to send identified URLs to the server for analysis (e.g. with respect to operation 406 of FIG. 4).

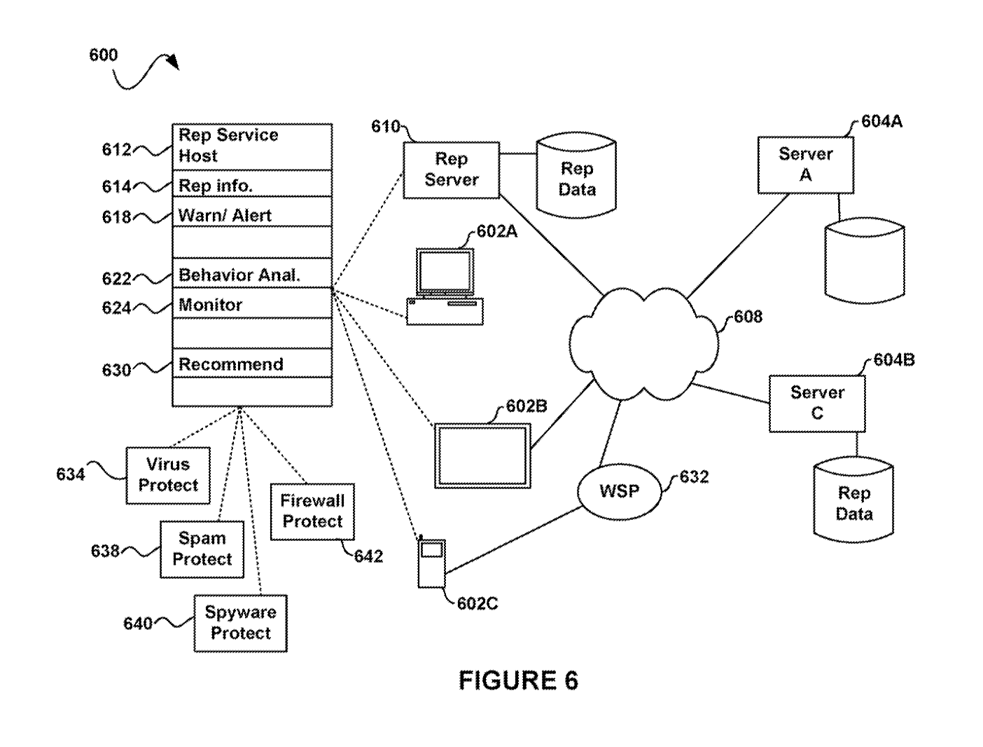

FIG. 6 shows a high level schematic of an interactive reputation-based platform 600, in accordance with still yet another embodiment. As an option, the platform 600 may be implemented in the context of the architecture and environment of FIGS. 1-5. Of course, however, the platform 600 may be implemented in any desired environment. Again, it should also be noted that the aforementioned definitions may apply during the present description.

The interactive reputation-based platform 600 may include a number of clients 602A-C which may be equipped with the client functionality set forth above in FIGS. 1-5. Such clients 602A-C interact with server applications 604 through an internetwork 608 (e.g. Internet, etc.). The clients 602A-C may interact with a reputation server 610, which may be equipped with the server functionality set forth above in FIGS. 1-5. In use, the clients 602A-C may download client software, software updates, browser plug-ins, and the like from the reputation server 610. In one embodiment, the clients 602A-C may interact with servers 604A-B through, or in coordination with, the reputation server 610.

The interactive reputation-based platform 600 may also include a reputation service host 612, which may be equipped with the functionality set forth above in FIGS. 1-5. The reputation service host 612 may be associated with the reputation server 610 and/or clients 602A-C. In one embodiment, a portion of the reputation service host 612 may reside on the clients 602A-C, and another portion may reside on the reputation server 610.

The reputation service host 612 may perform several functions related to reputation-based protection of the clients 602A-C. For example, the reputation service host 612 may perform services associated with gathering, storing, and/or providing reputation information 614 relating to certain web sites, activities, categories, types of interactions, content types, etc. The reputation service host 612 may also provide notifications 618, such as warnings, cautions, alerts, indications of acceptable reputation, indications of poor reputations, indications of reputations, indications of types of expected behaviors, etc.

The reputation service host 612 may additionally analyze behaviors 122 (e.g. user behavior, site behavior, corporate behavior, page behavior, advertising behavior, communications behavior, etc) associated with the reputation information 614. The reputation service host 612 may include a monitor 624 for monitoring performance (e.g. client system performance before and/or after a web interaction), as an option. In one embodiment, the reputation service host 612 may include a recommendation facility 630 (e.g. for making recommendations to a user of the client 602A-C based on a site reputation the user is attempting to interact with).

The reputation service host 612 may be embodied in hardware, software, firmware, middleware, or a combination of any of the foregoing. In one embodiment, the reputation service host 612 may include a server, such as an HTTP server, Web server, etc., as well as one or more other computing facilities, such as a processor, operating system, database, or communications facility, and one or more modules, such as modules for processing or executing algorithms or services. In another embodiment, the reputation service host 612 may include a single computer. In yet another embodiment, the reputation service host 612 may include more than one computer, such as in a distributed or parallel-processing system. In still yet another embodiment, the reputation service host 612 may include a cluster of services, such as those that are registered in the registry of a services oriented architecture.

Furthermore, a client 602A-C, for example, may attempt to interact with an application associated with a server 604A-B. The reputation service host 612 may have previously collected reputation information 614 relating to the application, and the reputation service host 612 may alert the user of the client 602A-C to the reputation before connecting the client 602A-C to the application. The reputation service host 612 may, for example, monitor an address or URL entered into an address bar of a browser application associated with the client 602A-C, and, after the user has entered the address, the reputation service host 612 may provide an alert to the user that the web site that the user is about to interact with has a reputation for downloading spyware, malware, or other unwanted content.

By way of another example, the client 602A-C may interact with a site, and the site may present a page requesting information, such as a user email address, credit card information, etc. The reputation service host 612, having previously collected information relating to how this provider treats such information, may provide the user with a warning of how the provider treats such information prior to submitting any such information. The client 602A-C may be presented with a warning when presented with the opportunity to enter such information, or the client 602A-C may be provided a warning after entering the information but before the information is sent to the provider, for example.

in one embodiment, when indicia of a reputation are presented, they may be presented along with evidence of the reputation at the time the user is making the interaction. For example, the presentation may include information relating to a number of pop-ups, type of virus, type of malware, type of spyware, type of identity theft, frequency of identity theft, site category (e.g. adult, travel, loan, children, teen, or retirement, etc.), and/or any other information capable of being associated with the interaction. In various embodiments, the evidence may have been produced through testing or developed through secondary sources, for example. In other embodiments, the presentation may be provided through visual indications, aural indications, multi-media indications, video indications, or otherwise.

The internetwork 608 of computing facilities may involve any number of different networking systems. For example, the internetwork 608 may involve client-server topologies involving wired, wireless, optical, satellite, or other connection types. The internetwork 608 may involve peer-to-peer, mobile client-cell phone network-server, mobile client-satellite network-server, mobile client-server relationships or other types of relationships. For example, a mobile communication facility 602 may connect to the internetwork 608 through a wireless service provider 632.

In one embodiment, the reputation service host 612 may recognize a type of client 602A-C and customize an interaction based on the type of client 602A-C. In another embodiment, the reputation server 610 may be duplicated and distributed throughout a region to provide faster access by clients 602A-C in the region. In various embodiments, the reputation server 610 may provide services, content, applications, updates, and the like to the clients 602A-C. In addition, the reputation server 610 may be used by the clients 602A-C in the interaction process with other servers 604A-B.

Still yet, the reputation service host 612 may be adapted to collect, store, organize, and/or provide reputation information 614 relating to web sites and the like. Examples of such information may include a wide range of indicia, which may relate to the quality of content of a site, page, or portion thereof; to behavior or other actions engaged in by a site or the host thereof; to attributes of the site or the host; or any other attributes of the site. Such information 614 may include information relating to spam, adware, spyware, cookies, viruses, phishing, spoofing, worms, illegal activities, immoral activities, illicit activities, improper business practices, etc. Each one of these factors, or any combination thereof, may be used as a basis for assessing the reputation of a site, a page, or a portion thereof, such as in association with a user's interaction with the same. Of course, it should be noted that the information 614 may encompass any type of information that can be used to derive an indicator of reputation or to serve as such an indicator.

As an option, one or more items or attributes of the reputation information 614 may be used to judge or establish an overall reputation of a site or to judge or establish a specific reputation parameter. Once a reputation parameter is established, it can be used in various ways, including, for example, a site that has a reputation for misusing private information may be tagged as a high risk site, and information about that risk may be presented to a user, such as at a time when a user is presented with an opportunity to enter such information. As another example, the user may be presented with an opportunity to download certain content from a web site with a poor reputation, and the reputation service host 612 may use the reputation information 614 to provide a notification 618 to the user prior to downloading the content.

In one embodiment, a reputation test may be performed or a reputation algorithm executed to assess or evaluate the reputation of a site, interactions with a site, etc. The test or algorithm may involve a collection phase, in which reputation information 614 is collected by various techniques, such as testing downloads, in order to determine whether and how they modify the test computer's file system and registry, whether they display pop up ads, etc. The collection phase may be undertaken by a variety of other techniques or facilities for collecting the information 614, such as by reading or parsing information on a site, aggregating content from multiple sites, spidering a network to identify sites with particular content or information, or a wide range of other information collection techniques. In one embodiment, information that is collected in the collection phase may be stored in a database, which may be optimized to store reputation information 614, such as for retrieval, analysis and use, in order to alert users at appropriate times.

In another embodiment, certain types of reputation information 614 may be associated with others in combinations or sub-combinations in order to allow rapid retrieval or analysis of combined categories of information. For example, indicators of spam, adware, and cookies may be associated with each other, and the presence of all three for a site may serve as secondary or “meta-indicator” of aggressive advertising behavior. In yet another embodiment, the reputation information 614 may be stored in a hierarchical fashion, such as including categories and sub-categories of information in a hierarchy or tree structure.

The reputation service host 612 may initiate a number of actions, alerts, cautions, warnings and the like during the client's 602A-C interaction with a server, other client 602A-C, or other facility. For example, the reputation service host 612 may initiate notifications 618, provide reputation information 614, provide recommendations 630, etc. based on the reputation information 614 accessible to the reputation service host 612. The reputation service host 612 may indicate various levels of warnings, indications, and alerts from cautionary statements to warnings and indications of danger. In embodiments, the level of warning may increase with increased participation, as, for example, when a user interacts with a particularly non-reputable site.

The notification 618, or other indication of reputation, may be based on one or more parameters (e.g. one or more indicia of reputation collected and stored as reputation information 614). In one embodiment, information may be provided indicating action or interaction is acceptable. For example, when presented with an information request on a site, the reputation service host 612 may provide an indication to the user that the site has an acceptable reputation for dealing with such information.

In one embodiment, notifications 618 may be provided with further information available. In another embodiment, the reputation service host 612 may provide a prevention service in such a way that an interaction or further interaction is prevented or only allowed to proceed with a user acknowledgement of the risk. In yet another embodiment, such acknowledgements may be recorded for later retrieval, etc.

The reputation service host 612 may include a behavior analysis service 622. The behavior analysis service 622 may be a manual or automated system for assessing the reputation of a web site based on the reputation information 614. In one embodiment, the behavior analysis service 622 may be an automated or semi-automated system. For example, an algorithm may be adapted to measure the duration of a web site's existence and compare it against a predetermined period. If the site has been in existence for a longer period than the predetermined period, the site may be deemed to have an acceptable reputation, or a parameter associated with the duration may be given a favorable value. The behavior analysis service 622 may also be adapted to analyze more than one parameter (e.g. indicia of reputation from the reputation information 614). In another embodiment, the behavior analysis service 622 may include one or more parameterized algorithms for determining an overall reputation of a site, a page, or a portion thereof.

The reputation service host 612 may include a recommendation facility 630. The recommendation facility 630 may be adapted to provide a user with a recommendation associated with an interaction the user is having or about to have with a site, page, or portion thereof or to provide alternate recommendations when the user is attempting to interact with a site with a poor reputation. The reputation service host 612 may also operate in coordination with a protection program, such as a virus protection program 634, a spam filter 638, a content filter, a parental control program, a spyware removal program 640, a firewall 642, or any combination thereof.

The reputation service host 612 may identify an interaction between the client 602A-C and a site, page, program, content item, or other item, such as a web site that is operated through a server 604A-B. If the site, for example, has a reputation of downloading viruses or other malware, the reputation service host 612 may operate in coordination with the virus protection program 634 to target any such undesired content that may have been downloaded to the client 602A-C. The virus protection program 634 may be used during any such site interactions to identify and protect the client 602A-C. In one embodiment, the reputation service host 612 may identify the potentially harmful content and or behavior and communicate such with the virus protection program 634. Such information may relate to the content and or the behavior. Once the information has been provided to the virus protection program 634, the virus protection program may search the client's 602A-C drives for all viruses or other malware, or it may target specific content identified by the reputation service host 612.

The reputation service host 612 may also be associated with the spam protection facility 638 (e.g. spam filter software residing on the client 602A-C or spam filter software residing on an associated server). The reputation service host 612 may detect a client 602A-C-server 604A-B interaction indicative of a spam attack, so the reputation service host 612 may send an indication of such to the spam protection facility 638. The spam protection facility 638 may then target spam from the interacted source or generally increase an activity associated with spam reviews. For example, any email identified as coming from the interacted source may be loaded into a folder for review and the user may be alerted to the fact that the email has been tagged as spam.

The reputation service host 612 may be further associated with the spyware protection facility 640 (e.g. spyware software resident on the client's server). For example, the reputation service host 612 may detect that the client 602A-C has interacted with or is about to interact with a site that has a reputation for downloading spyware, and the reputation service host 612 may inform the spyware protection facility 640 of such. The spy ware protection facility may then analyze the client 602A-C (e.g. search any drives associated with the client 602A-C) for spyware, and the spyware protection facility may target the types of spyware programs the interacted source has a reputation for downloading, or the spyware protection facility may search folders and the like the interacted source generally targets for storage.

The reputation service host 612 may additionally be associated with a firewall facility 642 (e.g. hardware of software firewalls). For example, the reputation service host 612 may identify high risk content, sites, and the like, and it may pass this information on to a firewall facility 642. The firewall facility 642 may then use this information to suspect content and interactions.

In yet another embodiment, the reputation service host 612 may be associated with a web filtering facility (not shown) adapted to identify content, prevent content, notify of content, or perform other like services. In yet another embodiment, the reputation service host 612 may be associated with a phishing protection facility adapted to filter phishing, identify phishing activities, identify legitimate sites (e.g. using a white list of known good sites), or provide other like services.

Still yet, the reputation service host 612 may be associated with a security or controlled access facility (not shown). For example, the security or controlled access facility may be a fingerprint reader, etc. Further, the reputation service host 612 may be associated with a monitoring device (not shown), such as a camera, microphone, sensor, or the like. Moreover, the reputation service host 612 may be associated with other software such as cryptography software.

Optionally, warnings, recommendations, and indicia of reputation may be provided at the time of the attempted interaction or when the opportunity for an interaction is presented. For example, when a user enters a URL in an address bar of a browser, the user may be presented with reputation-based services even before the user's client device 602A-C is connected to the intended site. This may happen by a process involving various steps, including allowing the user to enter the URL, having the reputation service host 612 identify the URL, and comparing the URL to known URLs with associated reputation information, and then either providing information relating to the URL or allowing the browser to continue the action of connecting to the site.

In other embodiments, the user may be presented with a site that includes the opportunity for a user to enter information, such as queries, personal information, email address information, credit card information, passwords, or the like, and the reputation service host 612 may alert the user with indicia of the site's reputation as the site is presented. This may be done through a site comparison with reputation information 614 and/or through a review of what is being asked for on the page. When information requests are found, the page, content, site, or affiliated company may be assessed for reputation, and an indicator of the reputation may be presented to the user, or other reputation services may be provided. As an option, the user may enter information into entry fields on a page, and the action of entering the information may initiate a reputation review of the page, site, content, corporate affiliations, etc.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

1. A method, comprising:
identifying tracking information associated with first content stored on a particular client, wherein the tracking information indicates a uniform resource locator (URL) of the first content;
evaluating data associated with the first content at a server to determine if the first content violates a policy that is provided for a plurality of clients, each of which includes a respective security program;
comparing the URL to a plurality of known URLs such that if a match is not found, the URL is assigned a high priority for being analyzed by the server that is to maintain a URL list that reflects unwanted and wanted categorization types;
updating the URL list and the respective security program of the plurality of clients with an analysis of the URL, wherein the analysis indicates whether particular content associated with the URL is wanted or unwanted, and wherein the analysis indicates a safety ranking for the particular content associated with the URL, and wherein the analysis is provided to the client as part of a scheduled service when use of resources of the client is limited; and
updating a reputation service host associated with the respective security program in order to indicate current reputation data associated with the URL list, wherein the reputation service host includes a recommendation facility configured to make recommendations to the particular client based on the reputation data and to monitor future client behavior associated with interactions involving additional URLs.

2. The method of claim 1, wherein the tracking information includes a cookie.

3. (canceled)

4. The method of claim 1, wherein the first content includes a web site.

5. The method of claim 1, wherein the data includes the first content.

6. The method of claim 1, wherein the data includes a uniform resource locator associated with the first content.

7. The method of claim 1, wherein the analysis includes categorizing the first content.

8. (canceled)

9. The method of claim 1, further comprising determining whether the data associated with the first content matches known data associated with known content.

10. The method of claim 9, wherein the known content has been previously analyzed.

11. The method of claim 9, wherein the known data is stored on the particular client.

12. The method of claim 9, wherein the determination is performed at the particular client.

13. The method of claim 9, wherein the determination is performed at the server.

14. The method of claim 9, wherein the data associated with the first content is sent to the server for analysis if it is determined that the data associated with the first content does not match the known data associated with the known content.

15. (canceled)

16. The method of claim 1, wherein the high priority is assigned to the data at the particular client prior to sending the data to the server.

17. The method of claim 1, wherein the high priority is indicated by a flag associated with the data.

18. A computer program product embodied on a non-transitory computer readable medium for performing operations, comprising:
identifying tracking information associated with content stored on a particular client, wherein the tracking information indicates a uniform resource locator (URL) of the content;
evaluating data associated with the content at a server to determine if the content violates a policy that is provided for a plurality of clients, each of which includes a respective security program;
comparing the URL to a plurality of known URLs such that if a match is not found, the URL is assigned a high priority for being analyzed by the server that is to maintain a URL list that reflects unwanted and wanted categorization types;
updating the URL list and the respective security program of the plurality of clients with an analysis of the URL, wherein the analysis indicates whether particular content associated with the URL is wanted or unwanted, and wherein the analysis indicates a safety ranking for the particular content associated with the URL, and wherein the analysis is provided to the client as part of a scheduled service when use of resources of the client is limited; and
updating a reputation service host associated with the respective security program in order to indicate current reputation data associated with the URL list, wherein the reputation service host includes a recommendation facility configured to make recommendations to the particular client based on the reputation data and to monitor future client behavior associated with interactions involving additional URLs.

19. A system, comprising:
a processor coupled to a memory, wherein the system is configured for:
identifying tracking information associated with content stored on a particular client, wherein the tracking information indicates a uniform resource locator (URL) of the content;
evaluating data associated with the content at a server to determine if the content violates a policy that is provided for a plurality of clients having a respective security program;
comparing the URL to a plurality of known URLs such that if a match is not found, the URL is assigned a high priority for being analyzed by the server that is to maintain a URL list that reflects unwanted and wanted categorization types;
updating the URL list and the respective security program of the plurality of clients with an analysis of the URL, wherein the analysis indicates whether particular content associated with the URL is wanted or unwanted, and wherein the analysis indicates a safety ranking for the particular content associated with the URL, and wherein the analysis is provided to the client as part of a scheduled service when use of resources of the client is limited; and
updating a reputation service host associated with the respective security program in order to indicate current reputation data associated with the URL list, wherein the reputation service host includes a recommendation facility configured to make recommendations to the particular client based on the reputation data and to monitor future client behavior associated with interactions involving additional URLs.

20. The system of claim 19, wherein the processor is coupled to the memory via a bus.

21. The method of claim 1, further comprising receiving, at the particular client from the server, results of the analysis, wherein the results of analysis include an update to a definition file stored on the particular client.

22. The method of claim 21, wherein the definition file is utilized by the particular client for determining whether the data associated with the first content matches known data associated with known content, such that in response to a determination that the data associated with the first content does not match the known data associated with the known content, the data associated with the first content is sent to the server for the analysis.
